(19) United States
(12) Patent Application Publication
(10) Pub. No.: US 2007/0073772 A1
(43) Pub. Date: Mar. 29, 2007

(54) Productivity tracking for printer systems

(76) Inventors: Mary Colleen Blue, Longmont, CO (US); Weilin Chen, Longmont, CO (US); Brian Emery Mowrey, Longmont, CO (US); Christopher Philip David Reid, Erie, CO (US); Rodney Lee Sherwood, Longmont, CO (US); Kenneth Stuart Shouldice, Firestone, CO (US); Ronald Earl Van Buskirk II, Tucson, AZ (US)

Correspondence Address: LALLY & LALLY LLP, PO BOX 684749, AUSTIN, TX, 78768-4749, US

(21) Appl. No.: 11/281,292

(22) Filed: Nov. 17, 2005

Related U.S. Application Data
(60) Provisional application No. 60/720,003, filed on Sep. 23, 2005.

(51) Int. Cl. G06F 17/00

(52) U.S. Cl. 707/104.1

(57) ABSTRACT

A method for tracking printer productivity includes retrieving archived data stored on a remote printer that is connected to a network. The data is parsed and stored in a relational database. The data is retrieved from the database and used to generate a graphical representation of the data. The data may be represented as XML data and retrieving the data may include establishing a simple object access protocol (SOAP) connection between the printer system data and sending XML commands to the printer system. Storing the parsed data in a relational database may include establishing a Java database connectivity (JDBC) connection with a database server. The data is a log of events occurring on the printer system. The logged events may include status events indicating an operational status of the printer, job events indicating the beginning and ending of jobs, and intervention events indicating error status changes of the printer system.

This application claims the benefit of the provisional application entitled, Productivity Tracking Feature, Ser. No. 60/720,003 filed 23 Sep. 2005, which is incorporated by reference herein.

### BACKGROUND

1. Field of the Present Invention

The invention is in the field of printer systems and, more particularly, methods for tracking the productivity of commercial printer systems.

2. History of Related Art

Businesses that engage in production printing want to know how their printers have performed historically. Information regarding uptime, error conditions, status, consumables, and snapshots based on operators, print engines, or shifts are all of interest to production printing businesses. In addition, businesses need to have an accurate gauge of the true cost of printing including click charges, toner usage, and paper usage. The ability to track usage of consumables enables businesses to forecast accurately their needs in the future.

Printer manufacturers have attempted to address at least some of these requirements in small printer system applications. In a conventional productivity tracking application, a server that is connected to a printer system continuously monitors the printer system using a general purpose networking protocol such as SNMP (simple network management protocol). The more obvious drawbacks of this type of productivity tracking solution include the requirement that the server monitor the printer system continuously and the use of a general purpose networking protocol to convey the data. If the server stops monitoring the printer system for even a short duration, potentially valuable information may be lost. The use of a general purpose protocol is not optimized or customizable for printer system applications. Accordingly, it would be desirable to implement a printer system productivity tracking tool to address these shortcomings.

### SUMMARY OF THE INVENTION

The identified objective is addressed by a method and system for tracking printer productivity that includes retrieving archived data stored on a remote printer that is connected to a network. The data is parsed and stored in a relational database. The data is retrieved from the database and used to generate a graphical representation of the data. The data may be represented as XML data and retrieving the data may include establishing a simple object access protocol (SOAP) connection between the printer system data and sending XML commands to the printer system. Storing the parsed data in a relational database may include establishing a Java database connectivity (JDBC) connection with a database server. The data is a log of events occurring on the printer system. The logged events may include status events indicating an operational status of the printer, job events indicating the beginning and ending of jobs, and intervention events indicating error status changes of the printer system.

### BRIEF DESCRIPTION OF THE DRAWINGS

Other objects and advantages of the invention will become apparent upon reading the following detailed description and upon reference to the accompanying drawings in which:

FIG. 1 is a block diagram of selected elements of a printer system configuration emphasizing multiple printer systems in a networked environment according to an embodiment of the invention;

FIG. 2 depicts selected software elements of the printer system configuration of FIG. 1;

FIG. 3 depicts additional detail of an embodiment of the printer system configuration of FIG. 1 and FIG. 2;

FIG. 4 is a flow diagram illustrating selected elements of a method for retrieving performance data stored on a printer system according to an embodiment of the present invention;

FIG. 5 illustrates selected elements of a representational graphical user interface used in one embodiment of the invention;

FIG. 6 is an exemplary options menu suitable for use in the graphical user interface depicted in FIG. 5;

FIG. 7 is an exemplary help menu suitable for use in the graphical user interface depicted in FIG. 5;

FIG. 8 is an exemplary settings menu suitable for use with the options menu of FIG. 6;

FIG. 9 is an exemplary embodiment of a panel area of the graphical user interface of FIG. 5; and

FIG. 10 illustrates a exemplary format for a data type suitable for storing printer system data according to an embodiment of the invention.

While the invention is susceptible to various modifications and alternative forms, specific embodiments thereof are shown by way of example in the drawings and will herein be described in detail. It should be understood, however, that the drawings and detailed description presented herein are not intended to limit the invention to the particular embodiment disclosed, but on the contrary, the intention is to cover all modifications, equivalents, and alternatives falling within the spirit and scope of the present invention as defined by the appended claims.

### DETAILED DESCRIPTION OF THE INVENTION

A productivity tracking tool for printer systems is disclosed. The tracking tool includes an application to retrieve printer system data that is stored locally on one or more networked printer systems. The application parses the retrieved data and stores it in a relational database. The system preferably further includes templates or other interfaces to access the database and display the information in useful formats or graphs. In the preferred implementation, the data is retrieved by the application as XML (extensible markup language) data that is customizable for the particular application.

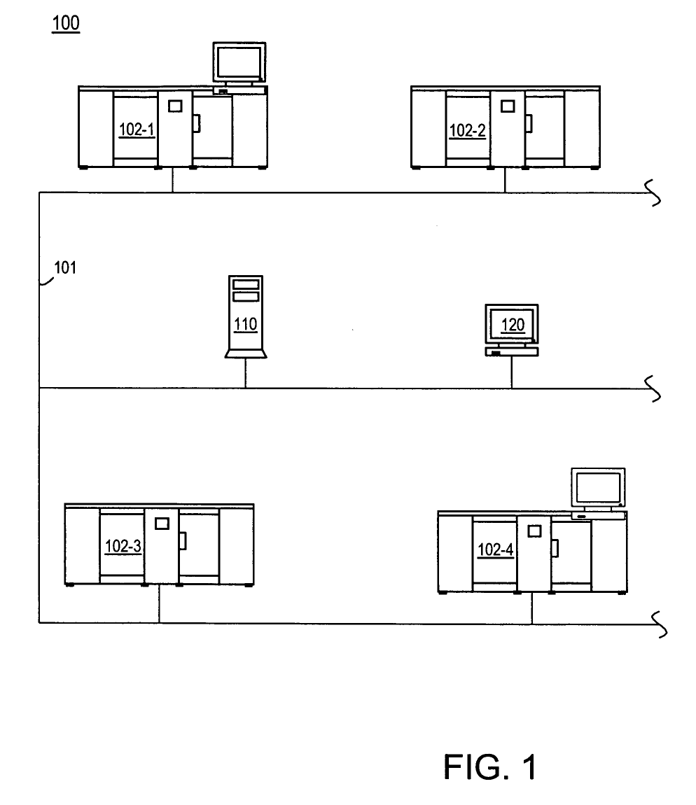

Turning now to the drawings, FIG. 1 depicts one embodiment of a printer system configuration 100. Printer system configuration 100 includes multiple printer systems 102-1 through 102-4 (generically or collectively referred to herein as printer(s) 102). In one embodiment, at least one printer 102 is an advanced functionality, continuous form printer. Printers 102 may include features of commercially distributed printers including, as examples, the Infoprint® 4000 and Infoprint® 4100 advanced function printer systems from IBM Corporation.

Printers 102 are connected to a local area network (LAN) 101. In the preferred embodiment, LAN 101 is a conventional Ethernet® LAN. Also connected to LAN 101 are a database server 110 and a productivity tracker (PT) system 120. PT system 120 is responsible for retrieving data from printer systems 102, parsing the retrieved data, and storing the parsed data on database server 110. Although PT system 120 and database server 110 are distinct physical systems as depicted in FIG. 1, the database server and productivity tracker application may be integrated on a single physical machine. In the depicted embodiment, PT system 120 may be implemented as a commercially distributed desktop computer system having a general purpose microprocessor (e.g., a PowerPC® processor from IBM Corporation or an x86-type microprocessor), a system memory, and a commercially distributed operating system such as a Windows® operating system from Microsoft corporation, a Unix-based operating system such as the AIX® operating system from IBM Corporation, or a Linux operating system.

Portions of the printer productivity application described herein may be implemented as a set or sequence of computer executable instructions (i.e., software). In such embodiments, the computer executable instructions may be stored on a computer readable medium such as a magnetic disk or other form of non-volatile storage device including flash memory devices, erasable and/or programmable read only memory (ROM's), optical disks including compact disks (CD's), digital versatile disks (DVD's), and the like. During execution, portions of the computer instruction may be stored in a volatile storage medium such as system memory or a processor's internal or external cache memory.

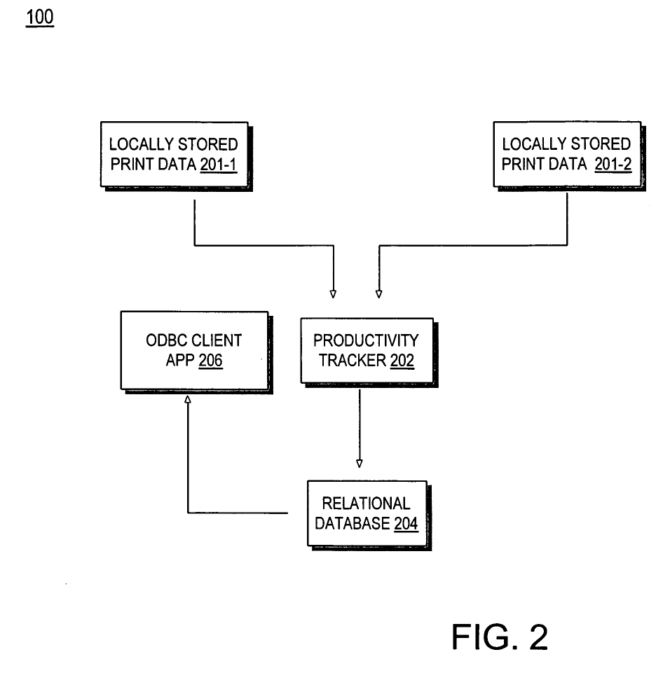

Referring now to FIG. 2, selected software components of an embodiment of printer system configuration 100 are depicted to emphasize the relationship among the various components. In the depicted embodiment, printer system configuration 100 includes a productivity tracker (PT) application 202, a relational database 204, and an open database connectivity (ODBC) client 206. The relationship between the software elements depicted in FIG. 2 and the hardware elements depicted in FIG. 1 is, at least to some extent, implementation specific. PT application 202 is preferably installed and executing on PT system 120. In one embodiment, referred to herein as a remote database embodiment, relational database 204 is stored on a different data processing system than the system on which PT application 202 is installed. In one implementation of the remote database embodiment, database server 110 of FIG. 1 hosts relational database 204. In other embodiments, referred to as local database embodiments, relational database 204 and productivity tracker 202 may be located on the same data processing system, in which case database server 110 and PT system 120 represent different functions of a common hardware element.

The location of ODBC client 206 may also vary depending upon the implementation. In one embodiment, ODBC client 206 and PT application 202 reside on PT system 120 while relational database 204 resides on database server 110. ODBC client 206 is responsible for retrieving printer productivity data stored in relational database 204 and presenting the data to a user in a meaningful format such as a graph, table, chart, or the like.

In the depicted implementation, PT application 202 is responsible for retrieving locally stored print data from each of the individual printer system(s) 102, two instances of which are indicated in FIG. 2 by references numerals 201-1 and 201-2 (generically or collectively referred to as locally stored print data 201). Locally stored print data 201 is archived data that is indicative of events logged by the printer system during operation of a printer system 102. Printer systems 102 generate real time logs of printer system events that occur during operation of printer system 102. Locally stored print data 201 is an archived record of these printer system event log entries.

PT application 202 preferably parses the log entries in the retrieved data and stores the parsed data in relational database 204. PT application 202 preferably also handles the configuration and management of database 204 and user options such as user language preferences and a polling interval, which controls the frequency with which PT application 202 retrieves data from printer system(s) 102. PT application 202 may execute in the background to retrieve data from printer systems 102 opportunistically such as when the load on the PT system 120 is otherwise low. The user will preferably assign a low operating system priority to PT application 202. In this manner, PT system 102 need not be dedicated solely for the purpose of acting as a printer system server, but may instead be used for other tasks.

ODBC client 206 retrieves data from database 204 and presents it to the user in a graphical format or another user friendly format. ODBC client 206 may employ standardized or predetermined templates to simplify the user's task of generating meaningful presentations of the data. The predetermined templates may include templates for generating charts or graphs for the following productivity parameters: Percent Time Printing, Snapshot Changes (showing the number of snapshot changes occurred per time interval), Estimated Click Count (shows click count over time), Estimated Toner Changes (a bar chart showing estimated number of toner changes per time interval), Error Frequency (showing the type of errors occurred and the percentage of their frequency), and Feet Printed (shows feet printed per time interval).

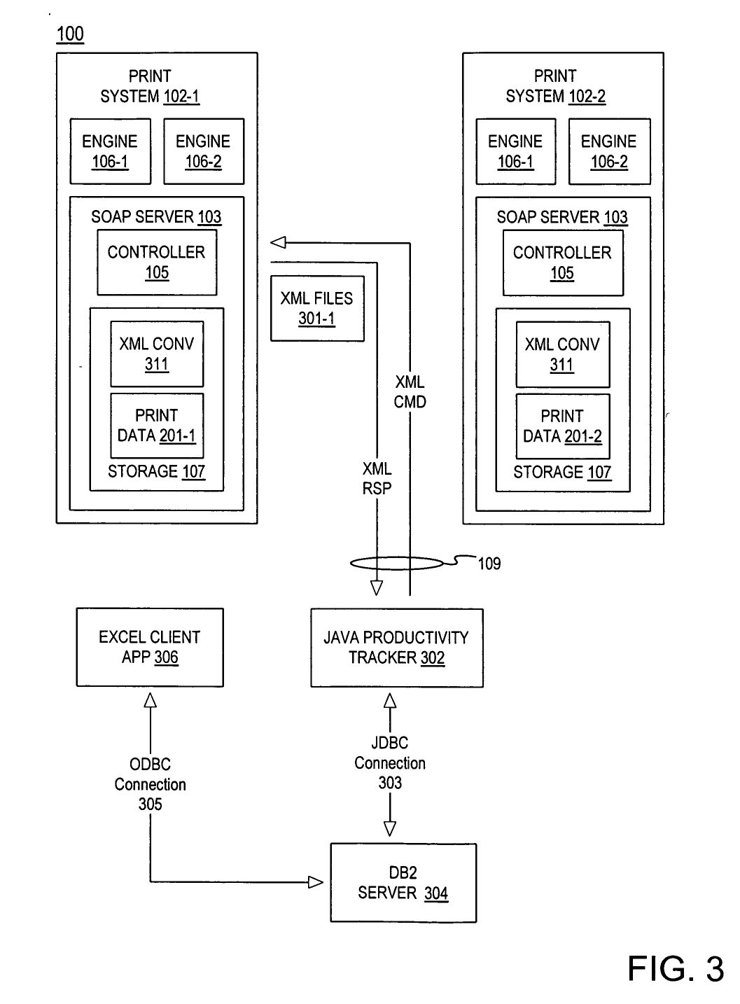

Turning now to FIG. 3, additional detail of an implementation of printer system configuration 100 is depicted. In the implementation depicted in FIG. 3, each printer system 102 includes first and second print engines 106-1 and 106-2 (generically or collectively referred to as print engine(s) 106), a printer controller 105 that controls both engines 106, and non-volatile storage 107 accessible to printer controller 105. Storage 107 may be implemented with conventional hard disk storage or with other suitable forms of nonvolatile storage.

Print engines 106 represent the physical print hardware. Printer controllers 105 are general purpose or application specific processors exemplified by the AFCCU (advanced function common control unit) controllers from IBM Corporation. AFCCU controllers are reduced instruction set computer (RISC) processors that contain a common set of code for all supported printer systems. In embodiments where printer system 102 includes an AFCCU controller 105 and two print engines 106-1 and 106-2, printer system 102 may operate in a dual simplex mode or a duplex mode. In dual simplex mode, each printer engine 106 prints a separate simplex job. In duplex mode, each printer engine 106 prints one side of a duplex job from controller 105.

In the implementation depicted in FIG. 3, a Java® productivity tracker (JPT) 302 serves as the PT application 202 depicted in FIG. 2. JPT 302 communicates with printer systems 102-1 and 102-2 to retrieve print data stored in those systems. In the depicted embodiment, locally stored print data 201 is stored in storage 107 in a binary format that may be an open or proprietary format. In the preferred embodiment, SOAP server 103 includes an application, identified as XML conversion application 311, that converts the binary-formatted print data 201 to an XML compliant format depicted in FIG. 3 as XML files 301-1. In a variant of the depicted embodiment, locally stored print data 201 is stored natively by controller 105 as XML data that does require conversion when retrieved by JPT 302.

Printer systems 102 as depicted in FIG. 3 include software, middleware, and/or hardware, including controller 105 and storage 107, required to implement a simple object access protocol (SOAP) server identified by reference numeral 103. SOAP is a protocol for exchanging XML-based information between peers in a decentralized, distributed environment. SOAP includes an envelope that defines a framework for describing what is in a message and how to process it, a set of encoding rules for expressing instances of application-defined data types, and a convention for representing remote procedure calls and responses.

SOAP does not govern the semantics of any application-specific data it conveys, the routing of SOAP messages, reliable data transfer, or firewall traversal. SOAP provides the framework by which application-specific information may be conveyed in an extensible manner and defines the required actions for a SOAP node that receives a SOAP message. Code suitable for use as a SOAP server application is available from the Apache Software Foundation.

JPT 302 communicates with SOAP server(s) 103 over a SOAP-compliant connection by sending XML commands to SOAP server 103 and receiving XML responses from SOAP server 103. In one embodiment, the SOAP connection between JPT 302 and SOAP server 103 uses a non-standard or custom TCP/IP port (e.g., port 10,000). JPT 302 uses the SOAP connection, identified by reference numeral 109, to retrieve XML files 301 containing printer system data. XML files 301 include logging entries generated by controller 105 during operation of the printer. The logging entries preferably contain information sufficient to derive values for a number of important performance and cost parameters associated with the corresponding printer system 102. Additional detail of the structure of XML files 301 according to one embodiment is described in below with respect to FIG. 10.

JPT 302 is further configured to parse the printer system data contained in XML files 301 and forward the parsed data to the database server. The generic database server 204 of FIG. 2 is implemented in FIG. 3 as DB2® server 304. DB2® is a well known family of relational database applications distributed by IBM Corporation. In the depicted embodiment, JPT 302 establishes a Java® database connectivity (JDBC) connection 303 with DB2® server 304 and uses JDBC connection 303 to send the printer system data after the data has been parsed by JPT 302. JDBC is an application program interface (API) for connecting to a wide range of structured query language (SQL) databases. JDBC also facilitates access to other types of tabular data sources including spreadsheets and flat files.

FIG. 3 also shows ODBC client application 206 of FIG. 2 implemented as an Excel® client application 306. Excel® client application 306 and DB2® server application 304 communicate via the ODBC connection 305. Excel® is a ubiquitous spreadsheet application from Microsoft Corporation. Excel® client application 306 is preferably configured with a set of defined templates that enable a user to generate a standardized set of graphs illustrating various parameters related to printer system performance. In the preferred embodiment, Excel® client application 306, when executed, displays an Excel-based GUI to the user. The GUI preferably enables the user to generate any of a number of predefined graphs or images. In addition, the GUI permits the user to generate a graph based on printer engines, operators, or shifts. With the printer engine selection facility, the user is able to view data corresponding to the first engine, the second engine, or both. Similarly, the operator selection facility enables the user to view data based on one or more individual operators or one of multiple work shifts (e.g., 8 to 4, 4 to 12, and 12 to 8).

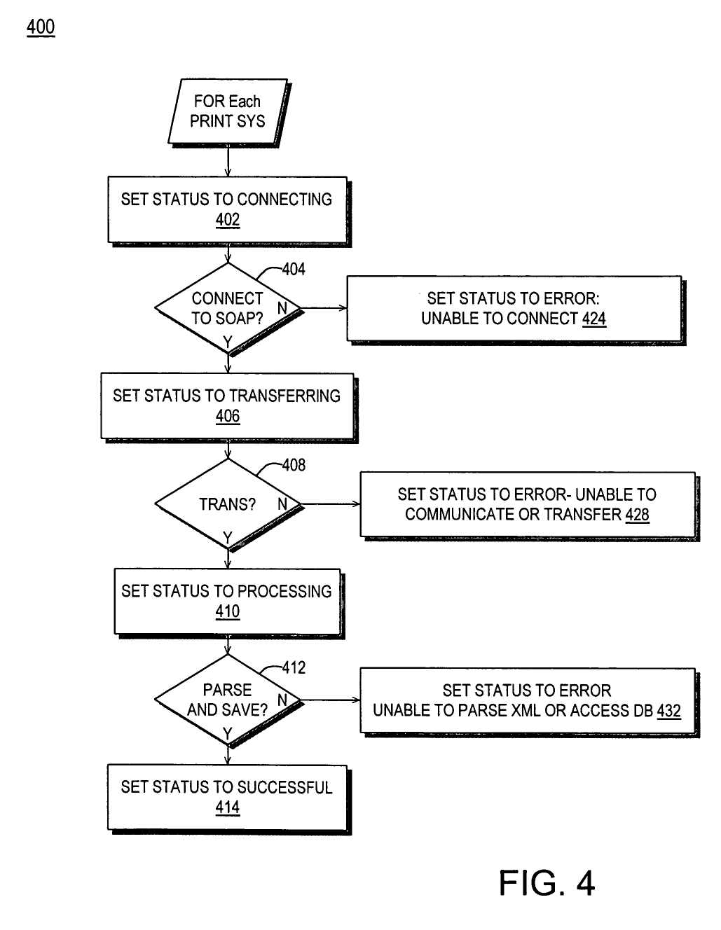

In one embodiment, PT application 202 of FIG. 2 and JPT application 302 of FIG. 3 are configured to retrieve locally stored print data 201 or XML files 301 automatically and periodically at predetermined intervals. Turning now to FIG. 4, a flow diagram illustrating selected elements of a process 400 of retrieving locally stored printer system data 201 from at least one and, preferably, two or more networked printer systems 102 is depicted. In the preferred embodiment, process 400 is executed by PT application 202 of FIG. 2 periodically at user-determined intervals.

As depicted in FIG. 4, process 400 includes setting (block 402) a status variable to “connecting” while PT application 202 attempts to establish a SOAP connection with the currently selected printer system 102. If PT application 202 cannot (block 404) successfully establish the SOAP connection, the status variable is set (block 424) to indicate that PT application 202 failed to establish the connection. If the connection is established, the status variable is set (block 406) to “transferring” while PT application 202 attempts to download locally stored printer data 201 from the currently selected printer system 102. If PT application 202 is unable (block 408) to download print data from a system, the status variable is updated (block 428) to indicate that the PT application 202 is unable to communicate with or transfer data from a printer system 102.

If the transfer of data completes successfully, the status variable is set to indicate that PT application 202 is processing (block 410) the downloaded print data. Processing 410 may include parsing XML formatted data retrieved from printer systems 102 by PT application 202 and saving the parsed data to relational database 204 in a database format such as DB2. In some embodiments, processing 410 also includes using the parsed data to calculate data that is of direct value to the end user and storing any such calculated data back into relational database 204. As an example, the data in XML files 301 retrieved from SOAP server 103 preferably includes printer system logging entries such as entries indicating when the status of the corresponding printer system transitions to a PRINTING status and logging entries indicating when the printer system status transitions to a STOPPED PRINTING status. It may be desirable for a user to know the percentage of time that a given printer system is actually printing. Processing 410 of FIG. 4 may include calculating the percentage of time or other parameters of interest from the printer system log entries and storing the calculated value in relational database 204. In this embodiment, the calculated parameters are parameters that may then be used “directly” by ODBC client application 206.

If PT application 202 is not able (block 412) to parse and save the data, the status variable is updated (block 432) to indicate that PT application 202 was unable to parse the stored data or to access the relational data base. If PT application 202 is able to process the stored data by parsing the data and saving it to the database, the status variable is set (block 414) to indicate successful completion of the transfer process. The sequence represented by blocks 402 through 414 is executed for each printer system 102 in printer system configuration 100.

Those skilled in the field of data processing systems generally and web-based software applications in particular will recognize that the printer system data retrieved from the printer systems 102 by PT application 202 occurs in several formats within the configuration 100. In the implementation depicted in FIG. 3, for example, print data 201 is stored in print system 102 in an open source or proprietary binary format. This binary data is converted to an XML format by XML converter 311 and transmitted over network connection 309 as XML data. JPT application 302 then parses the XML data and, optionally, calculates additional parameters from the parsed data, before storing the data on DB2® server 304 in a DB2® format. In this implementation, then, logging entries generated by print systems 102 may exist in a binary format, an XML format, or a DB2 format dependent upon the time and place within configuration 100.

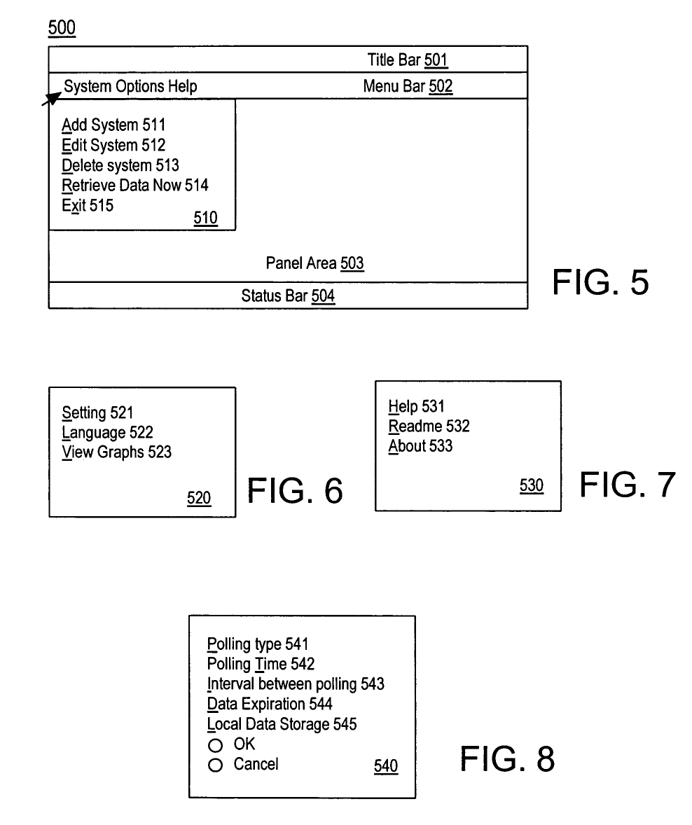

In the preferred embodiment, PT application 202 is configured to generate graphical user interfaces (GUI's) that facilitate interaction with the system user. Turning now to FIG. 5, one embodiment of a graphical user interface (GUI) 500 generated upon execution of PT application 202 is illustrated. In the depicted embodiment GUI 500, includes a title bar 501, a menu bar 502, a panel area 503, and a status bar 504. Preferably, the user can resize GUI 500. A default size of GUI 500 fits a 640×480 pixel display by default, although other default sizes can be accommodated. Bars 501, 502, and 504 are fixed height bars. Panel area 503 preferably expands and contracts with the height of the GUI 500. If the list of printer systems displayed in panel area 503 exceeds the size of panel area 503, a scroll bar (not depicted) appears on the right side of panel area 503.

Title bar 501 of GUI 500 contains the Title Text such as “Productivity Tracking Feature” in its center, standard icons for minimizing, maximizing, and closing the application on its right side, and possibly a logo icon on its left side. Menu Bar 502, according to one embodiment includes at least three menu items, namely, a “System” item, an “Options” item, and a “Help” item. When a user mouses over or clicks on the “System” item of menu bar 502, a drop down menu 510 containing selected System commands appears.

In the depicted embodiment, System menu 510 contains commands for adding (511) a printer system, editing (512) a printer system, deleting (513) a printer system, retrieving (514) data from a system immediately, and an exit command (515). Add System command 511 enables a user to add a system to the set of printer systems being monitored by PT application 202. Similarly, Edit System command 512 enables the user to modify the parameters associated with a system while Delete System command 513 removes a system from the configuration. Retrieve Data Now command 514 initiates an asynchronous retrieval of printer system data from each printer system 102 that is currently configured.

In one embodiment, the Options menu 520 depicted in FIG. 6 appears when a user selects the Options menu from GUI 500. The depicted embodiment of Options menu 520 includes commands for entering or modifying settings (521), modifying the application's language (522), and viewing graphs (523). The settings available through settings menu 521 are depicted in the exemplary menu 540 of FIG. 8. In this embodiment, the user accessible settings include a Polling Type parameter 541, a Polling Time parameter 542, an Interval Between Polling parameter 543, a Data Expiration parameter 544, and a Local Data Storage parameter 545. Polling Type parameter 541 determines whether polling of the stored data occurs based on set intervals or a set time of day. Depending upon the setting selected for Polling Type parameter 541, either the Polling Time parameter 542 or the Interval Between Polling parameter 543 is accessible to the user. Data Expiration parameter 545 indicates when data is considered stale and subject to removal, deletion, or being overwritten by the printer system.

When a user selects the Help item of menu bar 502 as depicted in FIG. 5, a help menu such as the exemplary help menu 530 depicted in FIG. 7 appears. In the depicted embodiment, help menu 530 includes a Help command 531, a Read Me command 532 and an About command 533. Help command 531 generates a help menu interface (not depicted) in a manner that will be familiar to most users of applications for desktop and notebook computers. Read Me command 532 may generate a text box indicating important information about the particular release of PT application 202 and GUI 500. About command 533 indicates release and revision information about GUI 500.

The commands and menus depicted in FIG. 5 through FIG. 8 are designed for intuitive use by those who may not have significant experience with production worthy printer systems. Upon selecting Add System command 511 from System menu 510 depicted in FIG. 5, for example, the user is presented with an Add System dialogue that enables the user to enter a name for the printer system and names for each engine in the system for multiple-engine systems. In the case of a new system, the add system dialogue will also enable the user to enter an IP address for the system. PT application 202 preferably checks each entry for compliance with predetermined restrictions such as restrictions on the number of characters in the system and engine names. A limitation of 50 characters for system names is imposed in one embodiment.

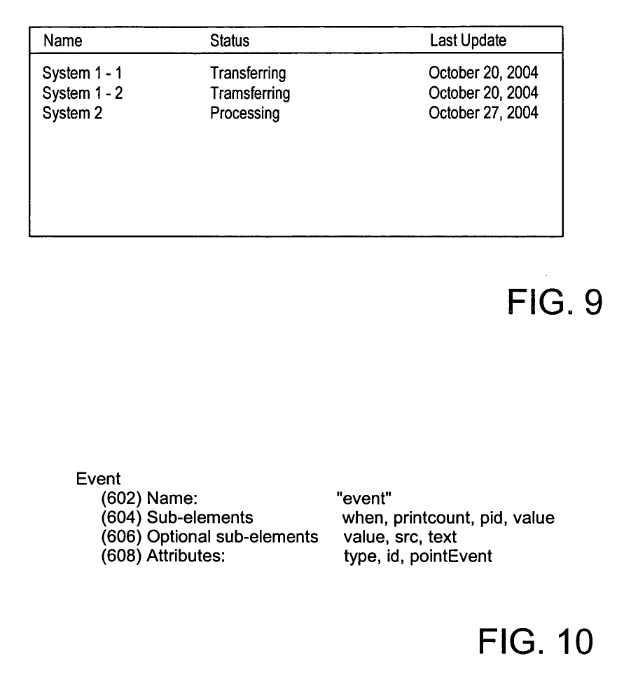

FIG. 9 depicts the format of an exemplary panel area 503 in which two printer systems have been added using Add System command 511. A first system (System 1) has two engines (System 1-1 and System 1-2) and is currently transferring stored data to PT application 202 as indicated in the status column of the display. A second system (System 2) has only a single engine, which has a status of processing, indicating that the application is currently processing data it has retrieved from the printer systems. The exemplary embodiment of panel area 503 also indicates the date of last update. In the depicted implementation, each printer engine is displayed within panel area 503 on its own line.

As indicated previously, PT application 202 retrieves locally stored print data 201 from the various printer systems. In one embodiment, locally stored print data 201 includes one or more log files that contain entries for several types of events including job events, snapshot events, configuration events, status events, and error events.

In some embodiments, XML files 301 of FIG. 3 are generated from binary formatted, locally stored print data 201 of FIG. 2. In other embodiments, locally stored print data 201 contains XML data files 301. Each XML data file 301 may be implemented as an XML node “printerEvents” that has zero or more sub elements of type “Event.” An exemplary format for an Event type 600 is depicted in FIG. 10. In the depicted embodiment, Event type 600 includes a Name field 602, a Sub-elements field 604, Optional sub-elements field 606, and Attributes field 608. Sub-elements field 604 includes a “when” parameter, a “printcount” parameter, a “pid” parameter, and a “value” parameter. In this embodiment, the “when” parameter may be implemented as a decimal string indicating the time that an event occurred in milliseconds. The “printcount” parameter preferably indicates a control unit estimate of the number of feet printed on a printer system engine and displayed on a console associated with the system. The printer id or “pid” parameter indicates the corresponding print engine. In a two-engine printer system, for example, a “pid” of 1 indicates a first engine, a pid of 2 indicates a second engine and a pid of 0 indicates that the corresponding data is engine independent. In one embodiment, a pid of 0 used to refer to the system control unit or otherwise to the printer system as a whole.

The attributes sub-element 608 of event type 600 as shown in FIG. 10 includes a “type” parameter, an “id” parameter, and a “pointEvent” parameter. The “pointEvent” parameter indicates whether ODBC client application 206 or Excel® client application 306 should display an event as a point or as a line covering the period from the opening of an event to the closing of the event. The “type” parameter identifies the type of printer system event. According to the embodiment depicted in FIG. 10, for example, the “type” parameter indicates one of five types of events, namely, “status” events, “intervention” events, “snapshot” events, “job” events, and “cookie” events. The “id” parameter is a type-unique sub-description of the event.

A status event indicates the operational status of a printer system and occurs whenever the status changes. The “id” parameter for a status event may be either “open” at the beginning of a period of known printer system status or “closed” at the end of a period of printer status. The “value” parameter for a status event may include, as examples, “shutdown”, “restart”, “error”, “not available”, “warming”, “sleeping”, “busy”, “printing”, “receiving”, “ready”, and “not ready”.

An intervention event (also referred to as an error event) provides information about printer system errors that occur during operation. The “id” parameter of an intervention event may have an “open” value when a new intervention error condition occurs, an “error acknowledged” value when the operator acknowledges the error, and a “closed” value indicating that a printer error has been cleared. An intervention event preferably contains a system reference code (SRC) indicating a code for the type of intervention, a pid value, and a text translation of the SRC.

A job event is logged at the beginning and ending of every print job. The “id” parameter for a “job” event may include a “job printing” value, a “job printed” value, or a “job aborted” value. The “value” parameter for an intervention event may indicate that name of the job, if one was entered.

A snapshot event is logged whenever a printer system snapshot is created, loaded, or modified. A snapshot is a prefined set of printer system configuration parameters that enables an operator to return to a frequently used configuration setting quickly. The “id” parameter for a snapshot event may have a “loaded” value when a snapshot was loaded into the printer system and a “modified” value when an existing snapshot is edited or otherwise altered. The “value” parameter for the snapshot event may identify the name of the snapshot if given.

A configuration event occurs whenever a printer system configuration changes. The “id” parameters for a configuration event type (also referred to as a cookie event type) may indicate one of many settings for a printer system. In one embodiment, for example, the “id” parameter of a configuration event may indicate, as examples, simplex vs. duplex mode, the identity of the operator, the level of toner, with a different parameter for each engine type, an oil level for both print engines, a value for the boldness settings of each engine, a contrast setting for each engine, a preheat temperature for both engines, and a fuser temperature for both engines. The configuration event type may indicate additional a parameters as well.

It will be apparent to those skilled in the art having the benefit of this disclosure that the present invention contemplates a system and method for tracking the productivity parameters of a printer system. It is understood that the form of the invention shown and described in the detailed description and the drawings are to be taken merely as presently preferred examples. It is intended that the following claims be interpreted broadly to embrace all the variations of the preferred embodiments disclosed.

What is claimed is:

1. A computer program product comprising computer executable instructions, stored on a computer readable medium, for monitoring productivity of a printer system, the instructions comprising:
instructions for retrieving, via a network connection, archived printer system data stored on a remote printer system connected to the network, wherein the archived printer system data is indicative of events logged by the printer system during operation of the printer system;
instructions for parsing the retrieved data and storing the parsed data in a relational database;
instructions for retrieving data from the database and, based thereon, generating a graphical representation of the data.

2. The computer program product of claim 1, wherein the instructions for retrieving the archived printer system data include instructions for converting a format of the archived printer system data to an XML format.

3. The computer program product of claim 2, wherein the instructions for retrieving the archived printer system data include instructions for establishing a simple object access protocol (SOAP) compliant connection between the printer system and instructions for sending XML commands to the printer system.

4. The computer program product of claim 3, wherein the instructions for storing the parsed data in a relational data include instructions for establishing a Java database connectivity (JDBC) connection with a database server.

5. The computer program product of claim 4, wherein the instruction for retrieving data from the database include instructions for establishing an open database connection (ODBC) with an ODBC client application.

6. The computer program product of claim 1, wherein the events logged by the printer system include status events indicating an operational status of the printer system, job events indicating the beginning and ending of printer jobs, and intervention events indicating error status changes of the printer system.

7. The computer program product of claim 4, wherein the events logged by the printer system further include configuration events indicating a current configuration of the printer system and snapshot events indicating a predetermined set of printer system configuration parameters.

8. The computer program product of claim 1, further comprising, instructions for calculating a productivity parameter from the parsed data and storing the calculated productivity parameter in the relational database.

9. The computer program product of claim 8, wherein the calculated productivity parameter is selected from the group of productivity parameters consisting of: percent time printing, snapshot changes per time interval, estimated click count over time, estimated toner changes per time interval, error frequency, and feet printed per time interval.

10. A method for monitoring productivity of a printer system, the instructions comprising:
retrieving, via a network connection, archived printer system data stored on a remote printer system connected to the network, wherein the archived printer system data is indicative of events logged by the printer system during operation of the printer system;
parsing the retrieved data and storing the parsed data in a relational database;
retrieving data from the database and, based thereon, generating a graphical representation of the data.

11. The method of claim 1, wherein retrieving the archived printer system data includes converting a format of the archived printer system data to an XML format.

12. The method of claim 11, wherein retrieving the archived printer system data includes establishing a simple object access protocol (SOAP) compliant connection between the printer system and sending XML commands to the printer system.

13. The method of claim 12, wherein storing the parsed data in a relational data includes establishing a Java database connectivity (JDBC) connection with a database server.

14. The method of claim 13, wherein retrieving data from the database includes establishing an open database connection (ODBC) with an ODBC client application.

15. The method of claim 10, wherein the events logged by the printer system include status events indicating an operational status of the printer system, job events indicating the beginning and ending of printer jobs, and intervention events indicating error status changes of the printer system.

16. The method of claim 15, wherein the events logged by the printer system further include configuration events indicating a current configuration of the printer system and snapshot events indicating a predetermined set of printer system configuration parameters.

17. The method of claim 10, further comprising, calculating a productivity parameter from the parsed data and storing the calculated productivity parameter in the relational database.

18. The method of claim 17, wherein the calculated productivity parameter is selected from the group of productivity parameters consisting of: percent time printing, snapshot changes per time interval, estimated click count over time, estimated toner changes per time interval, error frequency, and feet printed per time interval.

19. A computer program product comprising computer executable instructions stored on a computer readable medium, for tracking the productivity of a printer system, comprising:
instructions for establishing a simple object access protocol (SOAP) connection between the printer system and a productivity tracking system;
instructions for transferring archived data stored on the printer system to the productivity tracking system over the SOAP connection, wherein the archived data is indicative of a log of printer events occurring during operation of the printer system; and
instructions for processing the archived data stored on the printer system including instructions for parsing entries in the log of printer events, calculating a productivity parameter from the entries, and storing the parsed entries and calculated productivity parameter in a relational database.

20. The computer program product of claim 19, wherein the instructions for transferring the archived data include instructions for converting a format of the archived data from a binary format to an XML format and transferring the archived data as XML data.
